(19) United States
(12) Patent Application Publication
(10) Pub. No.: US 2023/0242022 A1
(43) Pub. Date: Aug. 3, 2023

(54) TEMPERATURE-CONTROLLED SEAT SYSTEM

(71) Applicant: Adient US LLC, Plymouth, MI (US)

(72) Inventor: Joseph A. Hebda, Trenton, MI (US)

(73) Assignee: Adient US LLC, Plymouth, MI (US)

(21) Appl. No.: 17/649,196

(22) Filed: Jan. 28, 2022

(51) Int. Cl. B60N 2/56; B60N 2/00; H05B 3/34

(52) U.S. Cl. CPC B60N 2/5685; B60N 2/5692; B60N 2/002; H05B 3/34; H05B 2203/029; H05B 2203/01

(57) ABSTRACT

A seat system for a vehicle including a seat base assembly, a seat back assembly coupled to the seat base assembly, and a temperature-control system disposed in at least one of the seat base assembly and the seat back assembly. The temperature-control system is deactivated when the seat system is unoccupied and activated when the seat system is occupied. The temperature-control system includes a first conductive layer, a second conductive layer disposed adjacent the first conductive layer, and a plurality of thermal energy elements disposed between the first conductive layer and the second conductive layer.

### FIELD

The presently disclosed subject matter relates to a seat system, and more particularly to a temperature-controlled seat system for a vehicle.

### BACKGROUND

Conventional seat systems, particularly seat systems employed in a vehicle, include a seat back assembly connected to a seat base assembly and a headrest assembly. Portions of each of the seat back assembly, the seat base assembly, and the headrest assembly and other surfaces of the vehicle may be heated and/or cooled to provide comfort to an occupant of the seat system. In the prior art, the heated seat systems are activated by a console-mounted switch which the occupant activates to begin the heating or cooling of a desired portion of the seat system. As such, a heating or cooling system may be activated even when the occupant is not seated in the seat system, or the heating or cooling system may not be activated until the occupant remembers to activate the switch.

As the automotive industry moves towards electric vehicles, it has become critically important to minimize a power consumption of each component of the vehicle in order to increase an efficiency of the vehicle.

Accordingly, it would be desirable to produce a temperature-controlled seat system for a vehicle, which simplifies manufacturability and decreases costs, while minimizing power consumption and maximizing vehicle efficiency.

### SUMMARY

In concordance and agreement with the present disclosure, a temperature-controlled seat system for a vehicle, which simplifies manufacturability and decreases costs, while minimizing power consumption and maximizing vehicle efficiency, has surprisingly been discovered.

In one embodiment, a temperature-control system for a seat system, comprises: a first conductive layer; a second conductive layer disposed adjacent the first conductive layer; and at least one thermal energy element disposed between the first conductive layer and the second conductive layer, wherein the temperature-control system is deactivated when the seat system is unoccupied and activated when the seat system is occupied.

As aspects of certain embodiments, the first conductive layer is produced from a rigid material.

As aspects of certain embodiments, the second conductive layer is produced from at least one of a flexible material and an elastomeric material.

As aspects of certain embodiments, the at least one thermal energy element is directly coupled to the first conductive layer.

As aspects of certain embodiments, a gap is formed between the at least one thermal energy element and the second conductive layer when the seat system is unoccupied.

As aspects of certain embodiments, the at least one thermal energy element is configured to provide at least one of heating and cooling to the seat system when an electrical current flows through the conductive layers and the at least one thermal energy element.

As aspects of certain embodiments, the temperature-control system further comprises a power source in electrical communication with at least one of the first conductive layer and the second conductive layer.

As aspects of certain embodiments, the temperature-control system further comprises a controller configured to selectively control a flow of an electrical current through at least one of the first conductive layer, the second conductive layers, and the at least one thermal energy element.

As aspects of certain embodiments, the temperature-control system further comprises a control element in electrical communication with the controller, wherein the control element is configured to function as an occupant override to deactivate the temperature-control system.

In another embodiment, a seat system, comprises: a seat base assembly, a seat back assembly coupled to the seat base assembly, and a temperature-control system disposed in at least one of the seat base assembly and the seat back assembly, wherein the temperature-control system is deactivated when the seat system is unoccupied and activated when the seat system is occupied.

As aspects of certain embodiments, the temperature-control system comprises: a first conductive layer; a second conductive layer disposed adjacent the first conductive layer; and a plurality of thermal energy elements disposed between the first conductive layer and the second conductive layer.

As aspects of certain embodiments, the thermal energy elements are directly coupled to the first conductive layer.

As aspects of certain embodiments, a gap is formed between the thermal energy elements and at least one of the first conductive layer and the second conductive layer when the seat system is unoccupied.

As aspects of certain embodiments, the second conductive layer directly contacts at least one of the thermal energy elements when the seat system is occupied, forming an electrical circuit which allows an electrical current to flow through the conductive layers and the at least one thermal energy elements to provide at least one of heating and cooling to the seat system.

As aspects of certain embodiments, each of the thermal energy elements is spaced apart having an interstice formed therebetween.

As aspects of certain embodiments, at least one of the thermal energy elements is one of an electrical conductor, a thermo-resistive element, and a thermoelectric cooling element.

As aspects of certain embodiments, the seat system further comprises a power source in electrical communication with at least one of the first conductive layer and the second conductive layer.

As aspects of certain embodiments, the seat system further comprises a controller configured to selectively control a flow of an electrical current through at least one of the first conductive layer, the second conductive layers, and the thermal energy elements.

As aspects of certain embodiments, the seat system further comprises a control element in electrical communication with the controller, wherein the control element is configured to function as an occupant override to deactivate the temperature-control system.

In yet another embodiment, a method for controlling a temperature of a seat system, comprises: providing a seat base assembly, a seat back assembly coupled to the seat base assembly, and a temperature-control system disposed in at least one of the seat base assembly and the seat back assembly, wherein the temperature-control system, comprises: a first conductive layer; a second conductive layer disposed adjacent the first conductive layer; and a plurality of thermal energy elements disposed between the first conductive layer and the second conductive layer; and at least one of deactivating the temperature-control system when the seat system is unoccupied and activating the temperature-control system when the seat system occupied.

### BRIEF DESCRIPTION OF THE DRAWINGS

The accompanying drawings are incorporated herein as part of the specification. The drawings described herein illustrate embodiments of the presently disclosed subject matter, and are illustrative of selected principles and teachings of the present disclosure. However, the drawings do not illustrate all possible implementations of the presently disclosed subject matter, and are not intended to limit the scope of the present disclosure in any way.

FIG. 1 is a left side front perspective view of a seat system according to an embodiment of the presently described subject matter, wherein the seat system includes a seat base assembly, a seat back assembly, and a headrest assembly;

FIG. 2 is a right side perspective cross-sectional view of the seat system of FIG. 1, wherein the seat system includes a seat frame having a seat base structure and a seat back structure coupled thereto, a cushioning member disposed on each of the seat base and seat back structures, and a seat cover disposed over each of the seat base and seat back structures;

FIG. 3 is a front perspective view of the seat system of FIGS. 1-2, wherein the seat system includes a temperature-control system disposed in the seat base assembly and a temperature-control system disposed in the seat back assembly, wherein the headrest assembly and the seat covers are not shown;

FIG. 4 is a schematic elevational view of a portion of the temperature-control system in an unoccupied state according to an embodiment of the presently described subject matter, wherein the temperature-control system includes a first conductive layer, a spaced-apart second conductive layer, and a plurality of thermal energy elements;

FIG. 5 is a schematic elevational view of the portion of the temperature-control system of FIG. 4 in an occupied state

FIG. 6 is a schematic top plan view of the portion of the temperature-control system of FIG. 5 in the occupied state; and

FIG. 7 is a schematic elevational view of the portion of the temperature-control system of FIGS. 5-6 in the occupied state.

### DETAILED DESCRIPTION

It is to be understood that the presently disclosed subject matter may assume various alternative orientations and step sequences, except where expressly specified to the contrary. It is also to be understood that the specific assemblies and systems illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise. Also, although they may not be, like elements in various embodiments described herein may be commonly referred to with like reference numerals within this section of the application.

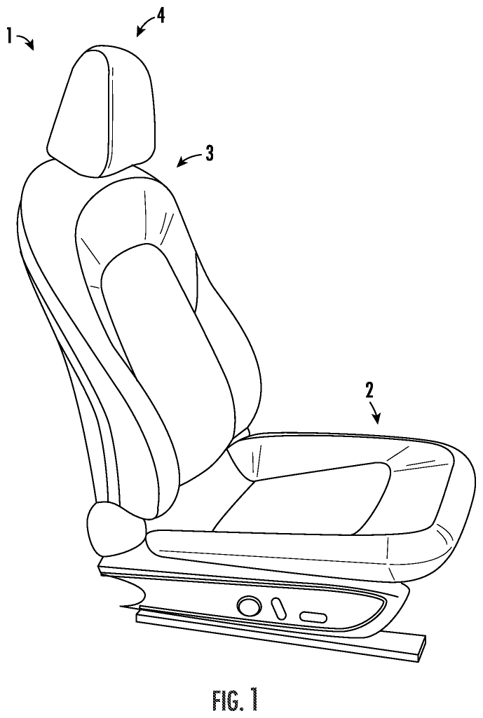

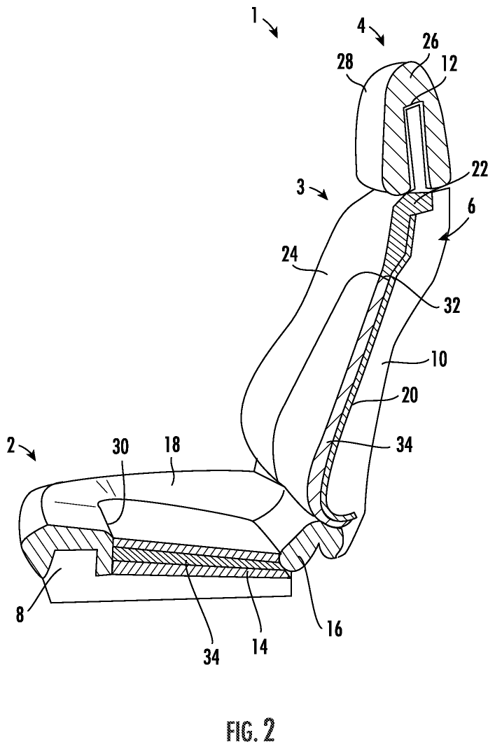

FIGS. 1-3 show a seat system 1 for a motor vehicle (not depicted) according to an embodiment of the presently disclosed subject matter. The seat system 1 may include a seat base assembly 2, a seat back assembly 3, and a headrest assembly 4. The seat back assembly 3 may be coupled to the seat base assembly 2 and the headrest assembly 4. In certain embodiments, the seat base assembly 2 may be movable relative to a floorboard of the vehicle, a seat back assembly 3 may be movable relative to the seat base assembly 2, and the headrest assembly 4 may be movable relative to the seat back assembly 3. The seat base assembly 2 may be configured to support a buttock portion and leg portion of an occupant 5. The seat back assembly 3 may be configured to support a back region of the occupant 5.

As illustrated, the seat system 1 may also include a seat frame 6. The seat frame 6 may comprise a seat base frame portion 8, a seat back frame portion 10, and a headrest frame portion 12. It is understood that the frame portions 8, 10, 12 may be coupled together using any suitable mean as desired. It is further understood that any suitable material may be employed to produce the frame portions 8, 10, 12 as desired. For example, each of the frame portions 8, 10, 12 may be formed from a rigid metal material.

In certain embodiments, the seat base assembly 2 may include a seat base substrate 14 coupled to the seat base frame portion 8, a cushioning member 16 disposed on the seat base substrate 14, and a seat covering or trim 18 disposed over the cushioning member 16. Similarly, the seat back assembly 3 may include a seat back substrate 20 coupled to the seat back frame portion 10, a cushioning member 22 disposed on the seat back substrate 10, and a seat covering or trim 24 disposed over the cushioning member 22. The cushioning members 16, 22 may be produced from any suitable material as desired such as a polymer material, for example. Preferably, each of the cushioning members 16, 22 may be produced from a polyurethane material.

The trim 18, 24 may include at least one inner layer disposed on an interior surface thereof. In certain embodiments, the inner layer may be produced from a foam laminate having a thickness in a range of about 3.0 mm to about 10 mm. It is understood that the inner layer may be produced from any suitable material having any suitable thickness, as desired.

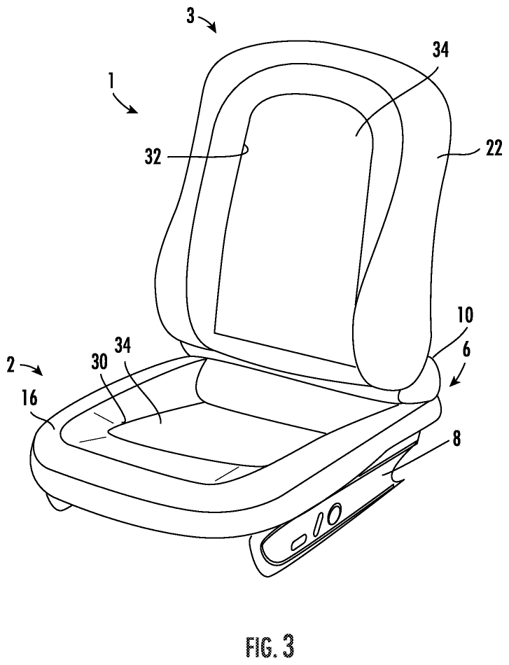

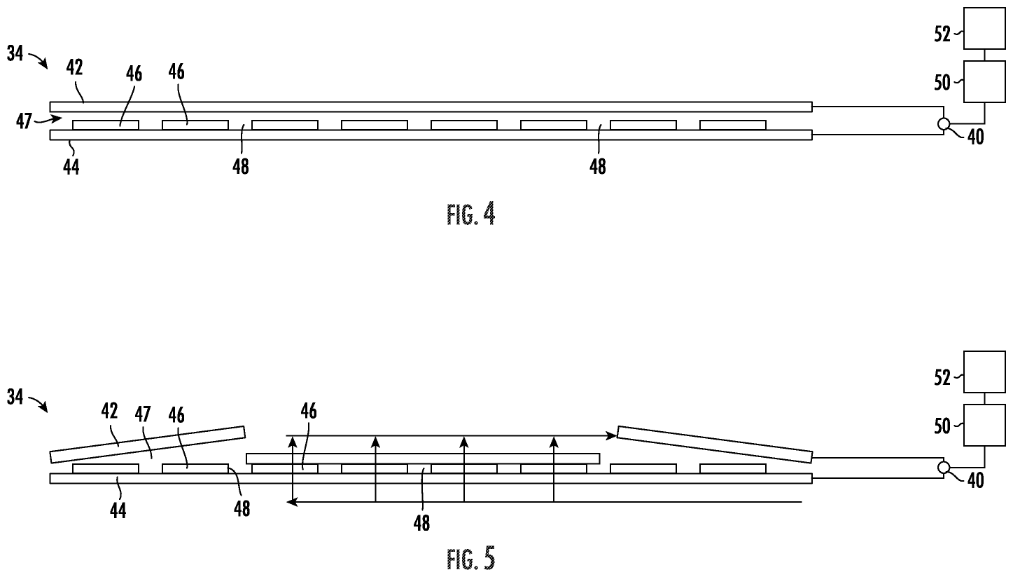

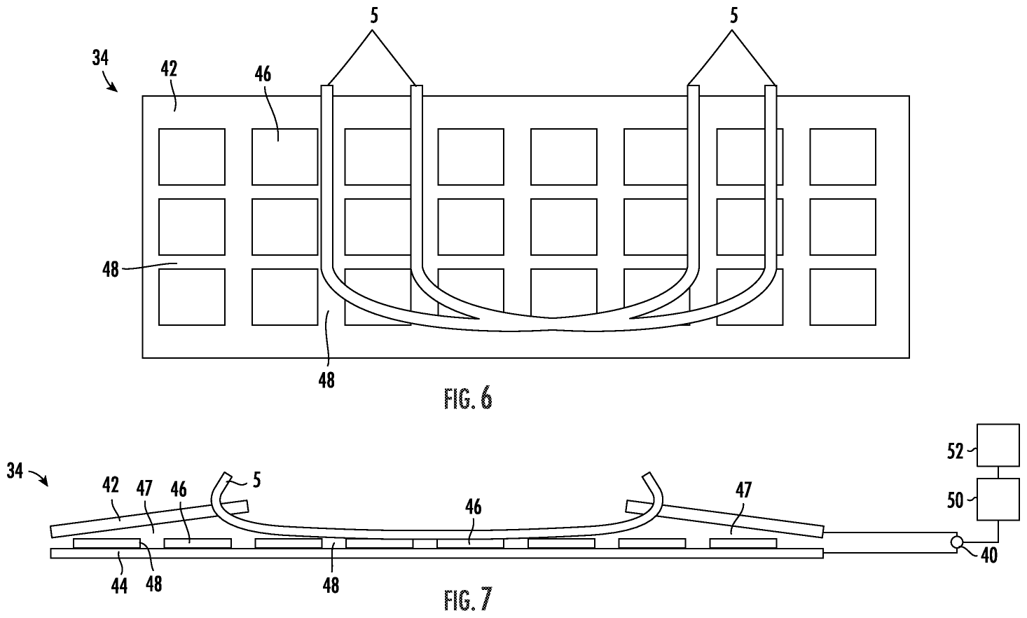

The headrest assembly 4 may include a cushioning member 26 disposed on the headrest frame portion 12 and a headrest cover 28 disposed over the cushioning member 26. In one embodiment, each of the cushioning members 16, 22 of the seat base assembly 2 and the seat back assembly 4, respectively, include respective voids 30, 32 formed therein. As shown more clearly in FIG. 3, the voids 30, 32 of the cushioning members 16, 22, respectively, may be shaped and sized to receive a temperature-control system 34, shown in FIGS. 4-7, therein. An overall shape, size, and configuration of the temperature-control system 34 may be substantially planar so as to reduce any protrusion of the temperature-control system 34 through the cushioning members 16, 22 and the trim 18, 24 and avoid any discomfort to the occupant 5 of the seat system 1.

The temperature-control system 34 may be configured to provide heat and/or cooling to the occupant 5 of the seat assembly 1. As shown in FIGS. 4, 5, and 7, the temperature-control system 34 may be in communication with a power source 40 configured to generate an electrical current.

In certain embodiments, each of the temperature-control system 34 may include a first conductive layer 42, a second conductive layer 44, and a plurality of thermal energy elements 46 disposed therebetween. The conductive layers 42, 44 and/or the thermal energy elements 46 may each be substantially planar. Each of the conductive layers 42, 44 may be produced for any suitable conductive material such as a metal material, for example. Additionally, the conductive material employed to produce one of the conductive layers 42, 44 may be rigid to militate against a flexing thereof; whereas the conductive material employed to produce a remaining one of the conductive layers 42, 44 may also be flexible and/or elastomeric to permit flexibility while militating against a permanent set thereof. As such, the at least one of the conductive layers 42, 44 has an ability to stretch moderate elongations and return to an original shape. In the embodiment shown, the first conductive layer 42 may be produced from a rigid conductive material and the second conductive layer 44 may be produced from a flexible and/or elastomeric conductive material. It should be appreciated that the material used to produce the first conductive layer 42 may be the same, or different from, the conductive material used to produce the second conductive layer 44.

Each of the conductive layers 42, 44 may be in electrical communication with the power source 40. In certain embodiments, the thermal energy elements 46 may be directly connected to only one of the conductive layers 42, 44. As illustrated, the thermal energy elements 46 may be directly connected to the first conductive layer 42. Each of the conductive layers 42, 44 and the thermal energy elements 46 may be configured to permit a flow of the electrical current from the power source 40 therethrough. In some embodiments, at least a portion of the thermal energy elements 46 may be electrical conductors each having a desired resistance which generate thermal energy (i.e. heats) as the electrical current from the power source 40 flows therethrough. It is understood that the thermal energy elements 46 may be any suitable electrical heating elements as desired such as a thermos-resistive element, for example. In other embodiments, at least a portion of the thermal energy elements 46 may be thermoelectric cooling elements which absorb thermal energy (i.e. cools) as the electrical current from the power source 40 flows therethrough. It is understood that the thermal energy elements 46 may be any suitable electrical cooling element as desired.

A gap 47 may be formed between the thermal energy elements 46 and at least one of the first conductive layer 42 and the second conductive layer 44 when the occupant 5 is not seated in the seat system 1. As such, the gap 47 militates against the flow of electrical current from the power source 40 through the conductive layers 42, 44. Hence, the temperature-control system 34 may be deactivated when the seat system 1 is unoccupied by an occupant 5. Accordingly, the seat system 1 may not unnecessarily generate or absorb thermal energy or draw power from the power source 40 when the seat system 1 is unoccupied.

When the seat system 1 is occupied by the occupant 5, a weight and a position of the occupant 5 may cause a downward pressure onto the seat base assembly 2 and/or a rearward pressure onto the seat base assembly 3, and thereby the second conductive layer 44. Such pressure causes the second conductive layer 44 to flex and contact at least one of the thermal energy elements 46 completing an electrical circuit. In some cases, a size, shape, and weight of the occupant 5 results in the second conductive layer 44 being in contact with only a portion of the thermal energy elements 46 and the gap 47 remains between a remaining portion of the thermal energy elements 46. Thus, a complete electrical circuit may only be created by the portion of the thermal energy elements 46 in contact with the second conductive layer 44 causing the flow of the electrical current from the power source 40 through only such portion of the thermal energy elements 46 to generate heat and/or provide cooling, resulting in optimized heating and/or cooling, and power consumption of the seat system 1. The heat generated and/or cooling provided by the thermal energy elements 46 may then be transferred through the cushioning members 16, 22 and the trim 18, 24 to provide the heating and/or cooling to the occupant 5.

In the embodiment shown, the thermal energy elements 46 may be arranged in a grid pattern having an interstice 48 formed between each of the thermal energy elements 46. The interstice 48 militates against electrical communication between the individual thermal energy elements 46. Thus, the grid pattern permits the individual thermal energy elements 46 to be electrically connected only in parallel and prevents them from being electrically connected in series, which results in the electrical circuit only being created by the portion of the thermal energy elements 46 contacted by the second conductive layer 44 when the seat system 1 is occupied by the occupant 5. It is understood, however, that the thermal energy elements 46 may arranged in any configuration as desired.

In certain embodiments, the temperature-control system 34 may further include a controller 50 in electrical communication with the power source 40 and a control element 52. The controller 50 may be configured to selectively control the flow of the electrical current from the power source 40. The control element 52 may include a thermostat, either preset or adjustable to allow the occupant 5 to control amount of heat and/or cooling produced by the temperature-control system 34. When the amount of heating and/or cooling produced by the temperature-control system 34 has not yet reached a desired level, the control element 52 remains deactivated. The control element 52, when deactivated, may communicate with the controller 50 which permits the flow of the electrical current from the power source 40 and normal operation of the temperature-control system 34. However, when the amount of heating and/or cooling produced by the temperature-control system 34 has reached the desired level, the control element 52 is activated and may communicate with the controller 50, which militates against the flow of the electrical current from the power source 40 and ceases the operation of the temperature-control system 34.

In certain embodiments, the control element 52 may also be employed as an occupant override to deactivate the temperature-control system 34 when the seat system 1 is not occupied by the occupant 5, but by an object that undesirably and inadvertently causes the second conductive layer 44 to contact the thermal energy elements 46 and would otherwise activate the temperature-control system 34.

While various embodiments have been described above, it should be understood that they have been presented by way of example, and not limitation. It will be apparent to persons skilled in the relevant arts that the disclosed subject matter may be embodied in other specific forms without departing from the spirit or essential characteristics thereof. The embodiments described above are therefore to be considered in all respects as illustrative, not restrictive.

What is claimed is:

1. A temperature-control system for a seat system, comprising:
a first conductive layer;
a second conductive layer disposed adjacent the first conductive layer; and
at least one thermal energy element disposed between the first conductive layer and the second conductive layer, wherein the temperature-control system is deactivated when the seat system is unoccupied and activated when the seat system is occupied.

2. The temperature-control system of claim 1, wherein the first conductive layer is produced from a rigid material.

3. The temperature-control system of claim 1, wherein the second conductive layer is produced from at least one of a flexible material and an elastomeric material.

4. The temperature-control system of claim 1, wherein the at least one thermal energy element is directly coupled to the first conductive layer.

5. The temperature-control system of claim 1, wherein a gap is formed between the at least one thermal energy element and the second conductive layer when the seat system is unoccupied.

6. The temperature-control system of claim 1, wherein the at least one thermal energy element is configured to provide at least one of heating and cooling to the seat system when an electrical current flows through the conductive layers and the at least one thermal energy element.

7. The temperature-control system of claim 1, further comprising a power source in electrical communication with at least one of the first conductive layer and the second conductive layer.

8. The temperature-control system of claim 1, further comprising a controller configured to selectively control a flow of an electrical current through at least one of the first conductive layer, the second conductive layers, and the at least one thermal energy element.

9. The temperature-control system of claim 8, further comprising a control element in electrical communication with the controller, wherein the control element is configured to function as an occupant override to deactivate the temperature-control system.

10. A seat system, comprising:
a seat base assembly;
a seat back assembly coupled to the seat base assembly; and
a temperature-control system disposed in at least one of the seat base assembly and the seat back assembly, wherein the temperature-control system is deactivated when the seat system is unoccupied and activated when the seat system is occupied.

11. The seat system of claim 10, wherein the temperature-control system, comprises:
a first conductive layer;
a second conductive layer disposed adjacent the first conductive layer; and
a plurality of thermal energy elements disposed between the first conductive layer and the second conductive layer.

12. The seat system of claim 11, wherein the thermal energy elements are directly coupled to the first conductive layer.

13. The seat system of claim 11, wherein a gap is formed between the thermal energy elements and at least one of the first conductive layer and the second conductive layer when the seat system is unoccupied.

14. The seat system of claim 11, wherein the second conductive layer directly contacts at least one of the thermal energy elements when the seat system is occupied, forming an electrical circuit which allows an electrical current to flow through the conductive layers and the at least one thermal energy elements to provide at least one of heating and cooling to the seat system.

15. The seat system of claim 11, wherein each of the thermal energy elements is spaced apart having an interstice formed therebetween.

16. The seat system of claim 11, wherein at least one of the thermal energy elements is one of an electrical conductor, a thermos-resistive element, and a thermoelectric cooling element.

17. The seat system of claim 11, further comprising a power source in electrical communication with at least one of the first conductive layer and the second conductive layer.

18. The seat system of claim 11, further comprising a controller configured to selectively control a flow of an electrical current through at least one of the first conductive layer, the second conductive layers, and the thermal energy elements.

19. The seat system of claim 18, further comprising a control element in electrical communication with the controller, wherein the control element is configured to function as an occupant override to deactivate the temperature-control system.

20. A method for controlling a temperature of a seat system, comprising:
providing a seat base assembly, a seat back assembly coupled to the seat base assembly, and a temperature-control system disposed in at least one of the seat base assembly and the seat back assembly, wherein the temperature-control system, comprises:
a first conductive layer;
a second conductive layer disposed adjacent the first conductive layer; and
a plurality of thermal energy elements disposed between the first conductive layer and the second conductive layer; and
at least one of deactivating the temperature-control system when the seat system is unoccupied and activating the temperature-control system when the seat system occupied.
